(19) United States
(12) Patent Application Publication
(10) Pub. No.: US 2014/0132516 A1
(43) Pub. Date: May 15, 2014

(54) OPTICAL KEYBOARD

(71) Applicants: HUO-LU TSAI, Taichung City (TW); Yung-Lung Liu, Taichung City (TW)

(72) Inventors: HUO-LU TSAI, Taichung City (TW); Yung-Lung Liu, Taichung City (TW)

(73) Assignee: Sunrex Technology Corp., Taichung City (TW)

(21) Appl. No.: 13/674,419

(22) Filed: Nov. 12, 2012

(51) Int. Cl. G06F 3/02

(52) U.S. Cl. CPC G06F 3/0202
USPC 345/168

(57) ABSTRACT

An optical keyboard includes a key assembly for alphanumeric data input; a keyboard housing being an integrally formed rectangular block for surrounding the key assembly, the keyboard housing including a left frame member, a right frame member, a rear frame member, and a front frame member; and at least one actuation sensing module disposed on a periphery of the keyboard housing, each of the at least one actuation sensing module including a light emitting member for emitting light directed to a predetermined space above the key assembly within the keyboard housing to create a sensing zone, and a photo sensor for sensing light emitted from the light emitting member.

### BACKGROUND OF THE INVENTION

1. Field of the Invention

The invention relates to optical keyboards and more particularly to an optical keyboard capable of toggling between an operating mode of pressing key and an operating mode of a key to be touched.

2. Description of Related Art

Touchscreen is an electronic visual display that can detect the presence and location of a touch within the display area. Touchscreens are common in devices such as game consoles, all-in-one computers, tablet computers, and smartphones.

They are a variety of touchscreen technologies that have different methods of sensing touch. These technologies include resistive, surface acoustic wave (SAW), capacitive, surface capacitance, projected capacitance, mutual capacitance, self-capacitance, infrared grid, infrared acrylic projection, optical imaging, dispersive signal technology, and acoustic pulse recognition.

A conventional optical keyboard comprises a keyboard housing having a matrix of rows and columns of apertures for keys, the housing having recesses open to the top of the keyboard between the apertures; and a plurality of keys for positioning in the apertures of the keyboard housing, each of the keys having an umbrella shaped cap with edges extending over the recesses between the apertures, whereby liquid and debris spilling on the umbrella shaped cap will fall into the recesses to be contained.

The conventional optical keyboard has been successfully used in a commercial application. However, its construction is complicated and cost ineffective. Thus, the need for improvement still exists.

### SUMMARY OF THE INVENTION

It is therefore one object of the invention to provide an optical keyboard comprising a key assembly for alphanumeric data input; a keyboard housing being an integrally formed rectangular block for surrounding the key assembly, the keyboard housing including a left frame member, a right frame member, a rear frame member, and a front frame member; and at least one actuation sensing module disposed on a periphery of the keyboard housing, each of the at least one actuation sensing module including a light emitting member for emitting light directed to a predetermined space above the key assembly within the keyboard housing so as to create a sensing zone, and a photo sensor for sensing light emitted from the light emitting member.

The above and other objects, features and advantages of the invention will become apparent from the following detailed description taken with the accompanying drawings.

### BRIEF DESCRIPTION OF THE DRAWINGS

FIG. 1 is a perspective view of an optical keyboard according to a first preferred embodiment of the invention;

FIG. 2 is a sectional view taken along line A-A of FIG. 1 showing a finger in the sensing zone detected by the actuation sensing module when the finger is about to press a key;

FIG. 3 is a view similar to FIG. 2 showing a further descending of the finger with the tip of the finger being about at the same elevation of the actuation sensing module; FIG. 4 is a top view of FIG. 1 showing different light reflection paths in the sensing zone in response to movement of the finger;

FIG. 5 is a block diagram of the optical keyboard according to the first preferred embodiment of the invention;

FIG. 6 is a perspective view of an optical keyboard according to a second preferred embodiment of the invention showing a key actuation sensing arrangement being provided on inner surfaces of a rectangular keyboard housing in the numeric keypad of the key assembly;

FIG. 7 is a view similar to FIG. 6 showing a touch panel being provided as a replacement of the numeric keypad of the key assembly in another configuration of the second preferred embodiment of the invention;

FIG. 8 is a perspective view of an optical keyboard according to a third preferred embodiment of the invention showing the actuation sensing modules provided on vertexes of a virtual triangle of a keyboard housing respectively; and

FIG. 9 is a front view of the optical keyboard of FIG. 8 showing the hand being in the sensing zone in a key actuation operation.

### DETAILED DESCRIPTION OF THE INVENTION

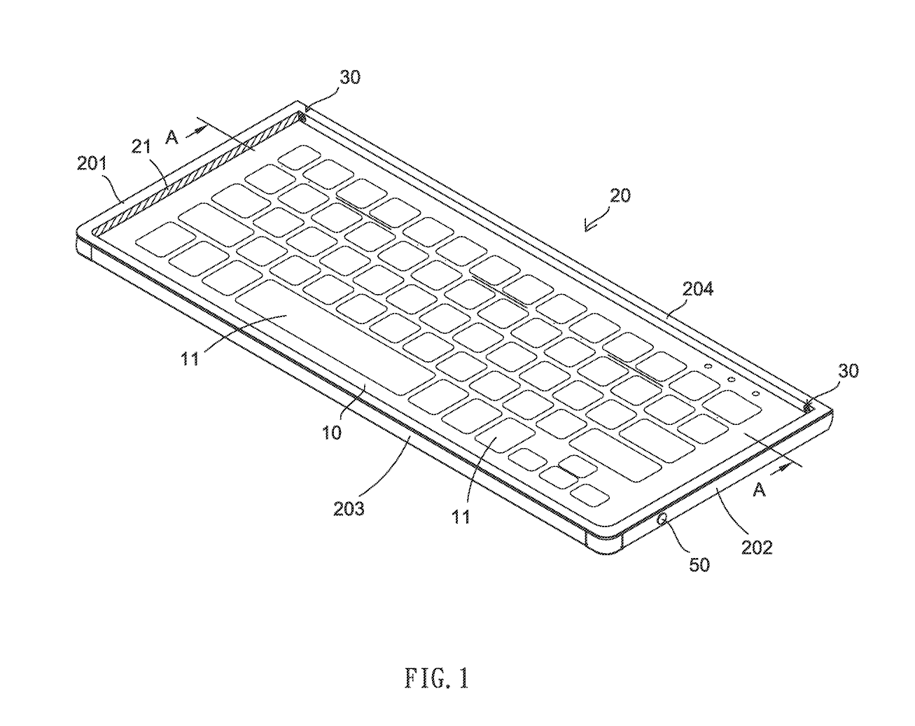

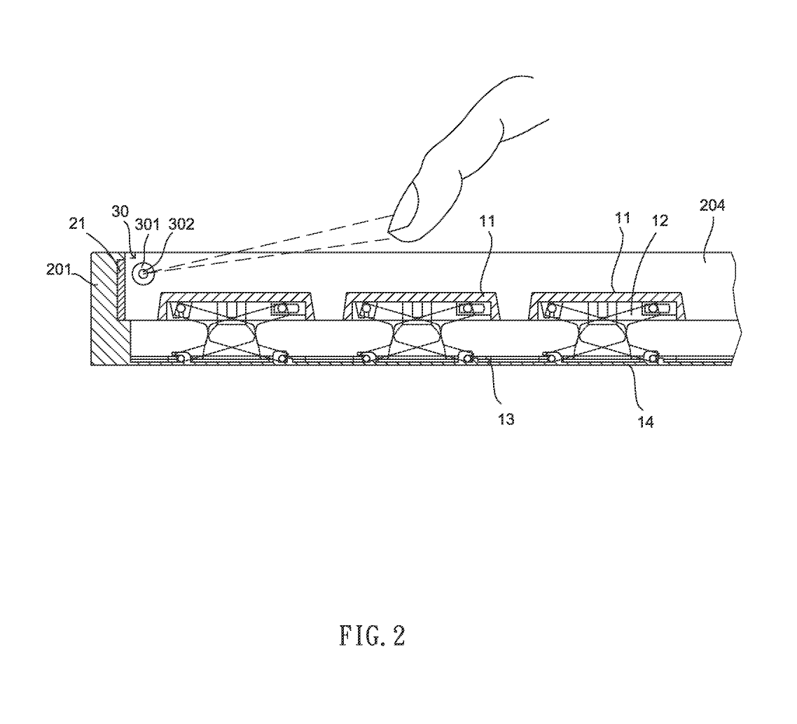

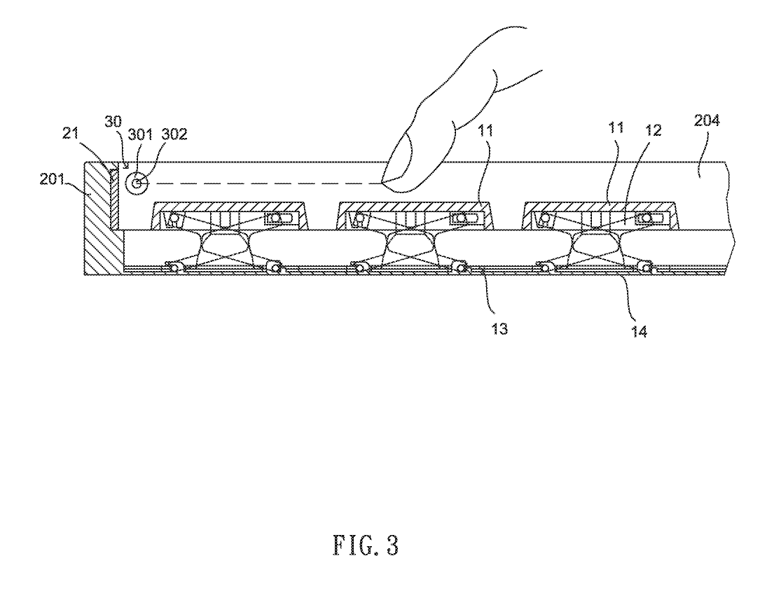

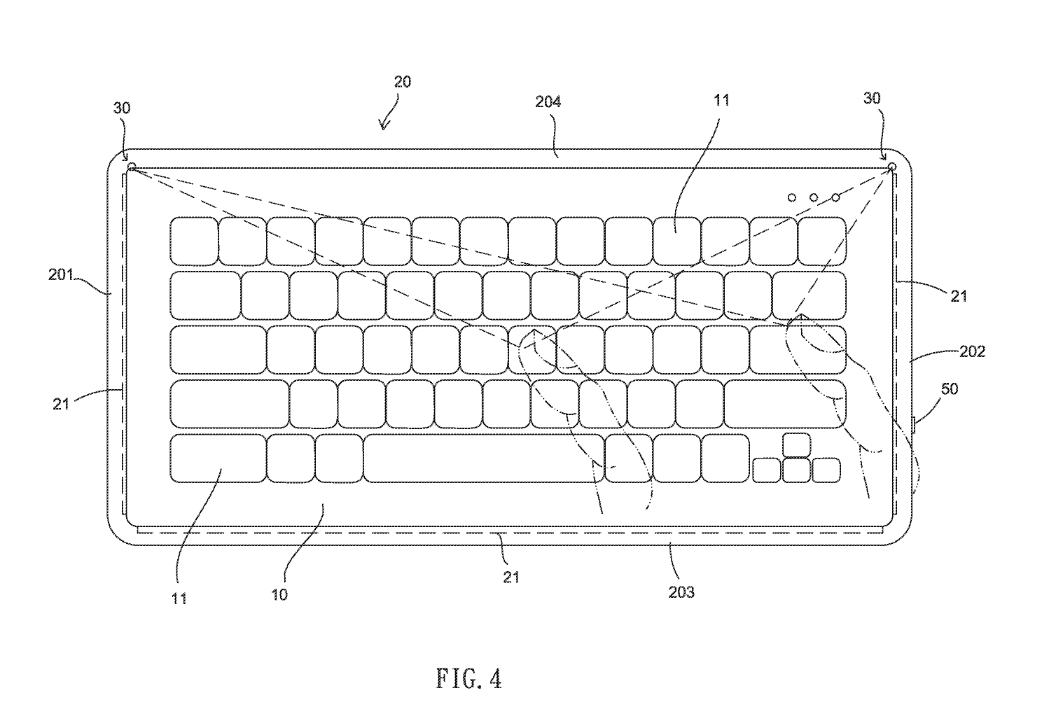

Referring to FIGS. 1 to 5, an optical keyboard in accordance with a first preferred embodiment of the invention comprises a key assembly 10, a keyboard housing 20, and two actuation sensing modules 30 as discussed in detail below.

The key assembly 10 comprises a plurality of keys 11 for input, a plurality of scissor-type structures 12, a film circuit board 13, and a base board 14. The key 11 is adapted to press and pivotably mounted on top of the scissor-type structure 12. The scissor-type structure 12 is a pivotal element and pivotably mounted on top of the base board 14. The film circuit board 13 disposed between the scissor-type structures 12 and the base board 14 serves as a conductive element in response to a depressing of the key 11. The base board 14 is a support under the film circuit board 13. Alternatively, the key assembly 10 is replaced with a touchscreen or a planar electronic input device in other embodiments.

The keyboard housing 20 is an integrally formed rectangular block for surrounding the key assembly 10. The keyboard housing 20 comprises a left frame member 201, a right frame member 202, a rear frame member 203, and a front frame member 204. A plurality of reflective members 21 are disposed on inner surfaces of the left frame member 201, the right frame member 202, and the rear frame member 203 respectively. The reflective members 21 are adapted to generate signals when light impinged thereon being blocked.

The actuation sensing modules 30 are disposed on both ends of the front frame member 204 of the keyboard housing 20 respectively. The actuation sensing module 30 comprises a photo sensor 301 for optically detecting an object (e.g., a finger) about to actuate the key 11, and a light emitting member 302 (e.g., light-emitting diode (LED)) for emitting red light. Preferably, the emitted light is invisible light such as infrared or ultra infrared in order not to be interfered by visible light. Light emitted by the light emitting members 302 is directed to a predetermined space above the keys 11 within the rectangular keyboard housing 20 to create a sensing zone. Light received by the photo sensors 301 is partially blocked when a finger is descending into the sensing zone to actuate a key 11. Strength of the light is thus decreased due to the blocking. Further, a signal is created by the photo sensors 301 due to changes of horizontal distance, vertical distance, and light angle, etc. The created signal is sent to a signal processing unit 33 for processing in order to determine whether the finger is sliding or about to press the key 11. Finally, a signal representing a key to be touched instruction containing a corresponding coordinate is created. Preferably, the photo sensor 301 is a complementary metal oxide semiconductor (CMOS) and has a wide angle image taking capability. The number and locations of the actuation sensing modules 30 can be changed based on the required image resolution. For example, in other embodiments, the photo sensors 301 are disposed in four corners of an inner surface of the keyboard housing 20 respectively in order to accurately detect the position of the finger touching the key 11 and carry out a multi-touch scheme.

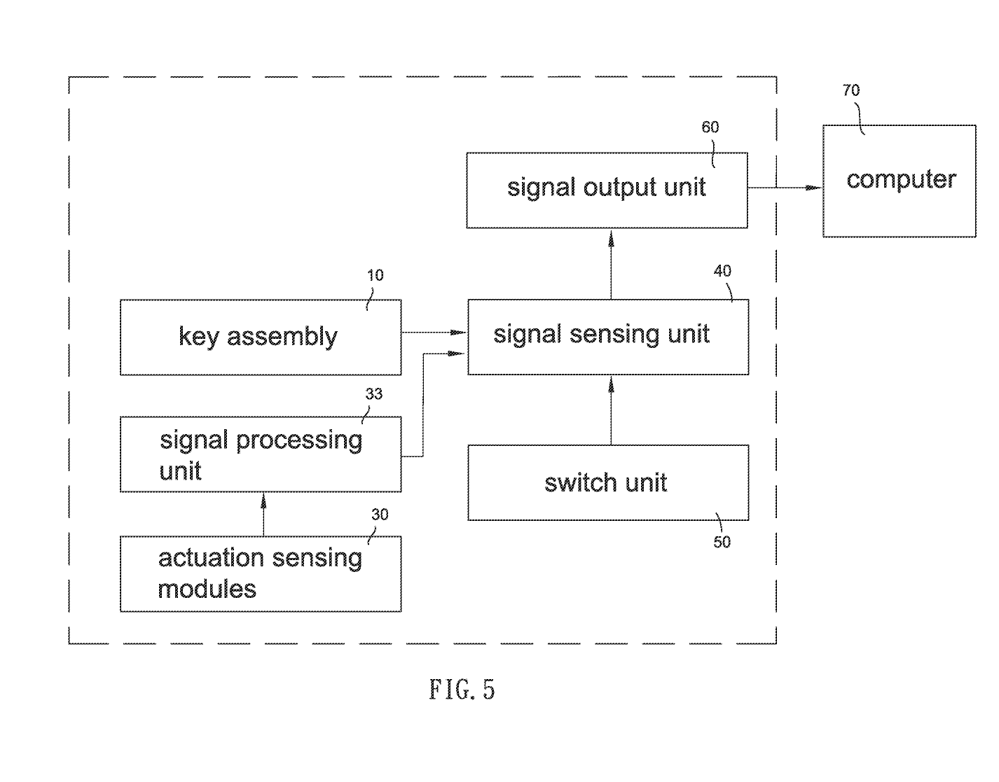

As shown in FIG. 5 specifically, the optical keyboard further comprises a switch unit 50, a signal sensing unit 40, and a signal output unit 60 as discussed in detail below.

The signal sensing unit 40 is electrically connected to the key assembly 10 and the signal processing unit 33 and adapted to determine a signal representing the depressed key 11 and a signal representing a key to be touched instruction containing a corresponding coordinate.

The switch unit 50 is electrically connected to the signal sensing unit 40 and adapted to toggle between an operating mode of pressing key and an operating mode of a key to be touched. The signal sensing unit 40 is responsive to a key depressing signal when the switch unit 50 is toggled to the operating mode of pressing key. Further, a signal representing the depressed key 11 is generated by the signal sensing unit 40 and transmitted to the signal output unit 60. To the contrary, the signal sensing unit 40 is responsive to a key to be touched signal when the switch unit 50 is toggled to the operating mode of a key to be touched. Further, a signal representing the key 11 to be touched is generated by the signal sensing unit 40 and transmitted to the signal output unit 60.

The signal output unit 60 is electrically connected to the signal sensing unit 40, adapted to receive either the signal representing the depressed key 11 or the signal representing the key 11 to be touched, and send the signal to a computer 70. The computer 70 can process the signal representing the depressed key 11 or the signal representing the key 11 to be touched and generate a corresponding character to be shown on a computer display. The signal output unit 60 is implemented as a wireless Bluetooth adapter or a wire universal serial bus (USB) adapter. Above electronic devices are powered by a battery (not shown) and detailed description thereof is omitted herein for the sake of brevity because they are well known in the art.

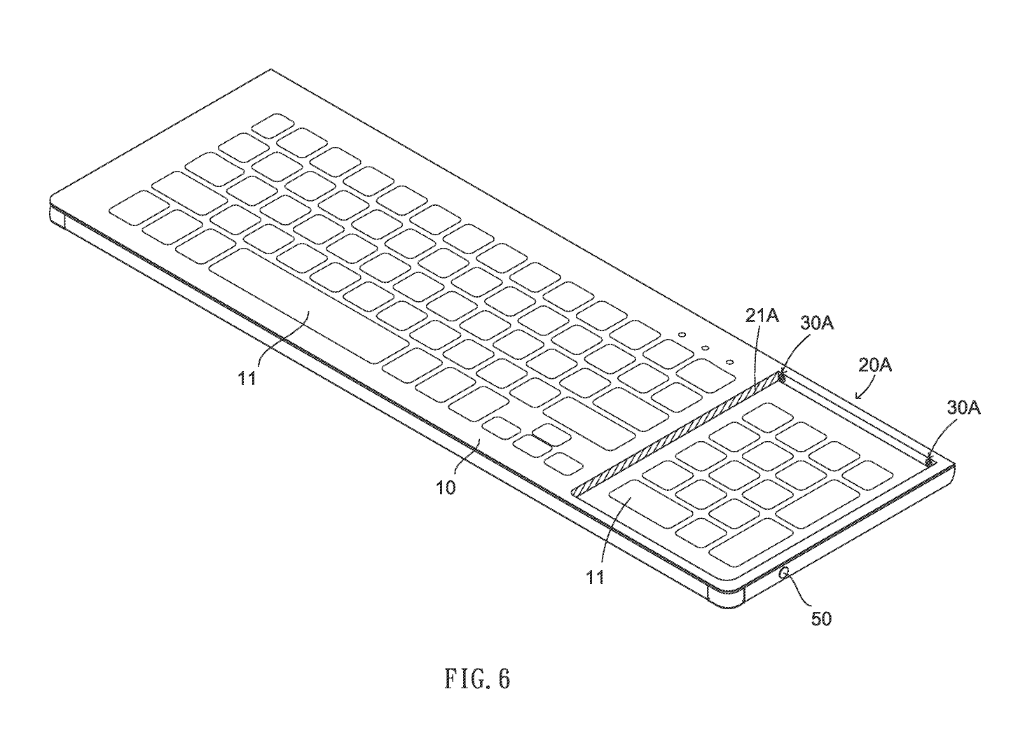

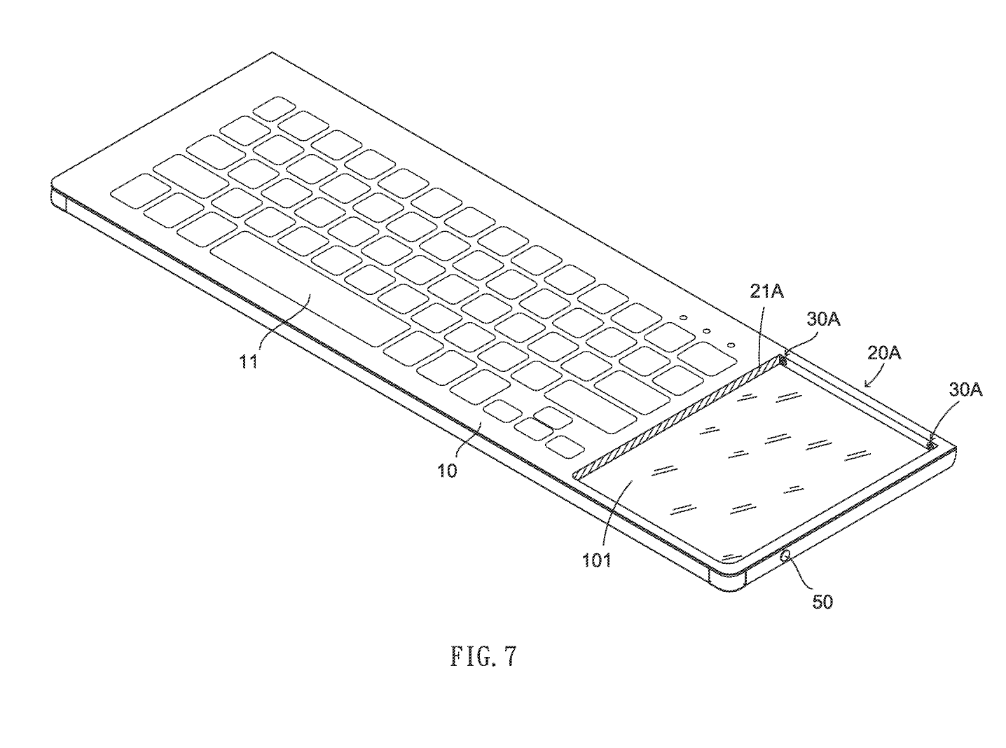

Referring to FIGS. 6 and 7, an optical keyboard in accordance with a second preferred embodiment of the invention is shown. The characteristics of the second preferred embodiment are substantially the same as that of the first preferred embodiment except the following: The sensing zone is disposed above a numeric keypad of the key assembly 10. In detail, a rectangular keypad housing 20A is provided in the numeric keypad of the key assembly 10 (see FIG. 6) or a touch panel 101 is provided in the keypad housing 20A as a replacement of the numeric keypad of the key assembly 10. A plurality of reflective members 21A are disposed on an inner surface of the keyboard a rectangular keypad housing 20A is provided on the numeric keypad of the key assembly 10 (see FIG. 6) or a touch panel 101 is provided a in the keypad housing 20A as a replacement of the numeric keypad of the key assembly 10. A plurality of reflective members 21A are disposed on an inner surface of the keypad housing 20A and two actuation sensing modules 30A are disposed on both ends of a front edge the keypad housing 20A respectively. Light emitted by the actuation sensing modules 30A is directed to a predetermined space above the keys 11 within the keypad housing 20A to create a sensing zone. The actuation sensing modules 30A are adapted to optically detect an object (e.g., finger) about to actuate the key 11 below the sensing zone and next generating a signal representing a key to be touched instruction containing a corresponding coordinate.

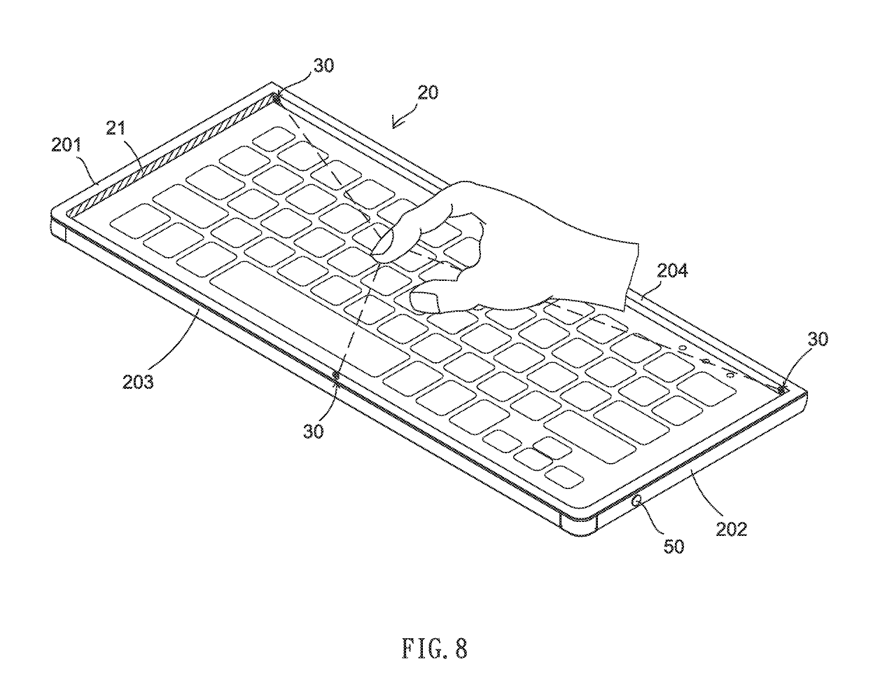

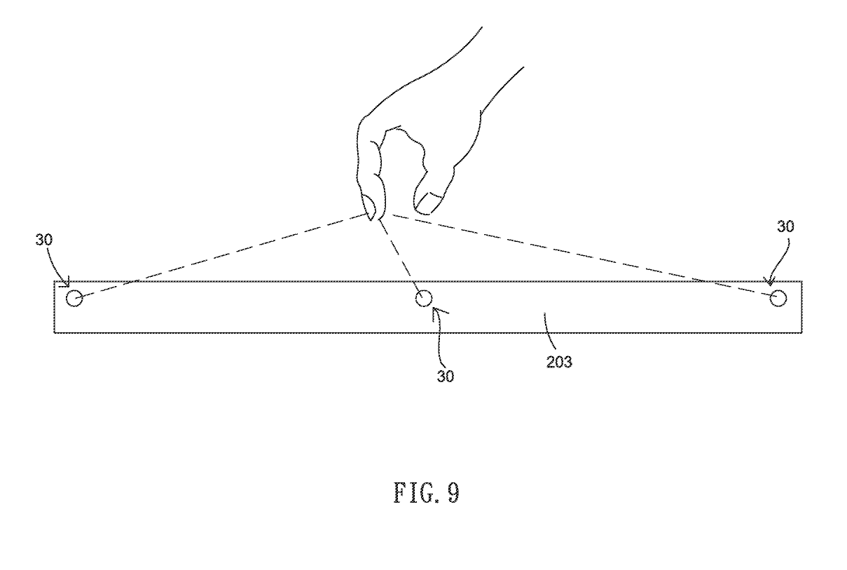

Referring to FIGS. 8 and 9, an optical keyboard in accordance with a third preferred embodiment of the invention is shown. The characteristics of the third preferred embodiment are substantially the same as that of the first preferred embodiment except the following: Three actuation sensing modules 30 are disposed at three vertexes of a virtual triangle on the keyboard housing 20. In detail, the actuation sensing modules 30 are disposed at both ends of the front frame member 204 and a midpoint of the rear frame member 203 respectively in order to accurately detect the position of the finger touching the key and carry out a multi-touch scheme.

While the invention has been described in terms of preferred embodiments, those skilled in the art will recognize that the invention can be practiced with modifications within the spirit and scope of the appended claims.

What is claimed is:

1. An optical keyboard comprising:
a key assembly for alphanumeric data input;
a keyboard housing being an integrally formed rectangular block for surrounding the key assembly, the keyboard housing including a left frame member, a right frame member, a rear frame member, and a front frame member; and
at least one actuation sensing module disposed on a periphery of the keyboard housing, each of the at least one actuation sensing module including a light emitting member for emitting light directed to a predetermined space above the key assembly within the keyboard housing to create a sensing zone, and a photo sensor for sensing light emitted from the light emitting member.

2. The optical keyboard of claim 1, wherein the key assembly comprises a plurality of keys, a plurality of scissor-type structures, a film circuit board, and a base board, and wherein the key is adapted to press and pivotably mounted on a top of the scissor-type structure, the scissor-type structure is a pivotal element and pivotably mounted on a top of the base board, the film circuit board disposed between the scissor-type structures and the base board serves as a conductive element in response to a depressing of the key, and the base board is a support under the film circuit board.

3. The optical keyboard of claim 1, further comprising a signal processing unit electrically connected to the at least one actuation sensing module for receiving and processing a signal representing a change of an optical path, the signal processing unit being adapted to determine whether a finger is sliding or about to press the key, and create a signal representing a key to be touched instruction containing a corresponding coordinate.

4. The optical keyboard of claim 3, further comprising a switch unit, a signal sensing unit, and a signal output unit, wherein the signal sensing unit is electrically connected to the key assembly and the signal processing unit and adapted to determine a signal representing the depressed key and a signal representing a key to be touched instruction containing a corresponding coordinate; the switch unit is electrically connected to the signal sensing unit and adapted to toggle between an operating mode of pressing key and an operating mode of a key to be touched; and the signal output unit is electrically connected to the signal sensing unit, adapted to receive either the signal representing the depressed key or the signal representing a key to be touched, and send the signal to a computer.

5. The optical keyboard of claim 1, further comprising a plurality of reflective members disposed on inner surfaces of the left frame member, the right frame member, and the rear frame member respectively, the reflective members being adapted to generate signals representing reflection when light directed toward itself being blocked.

6. The optical keyboard of claim 1, wherein the photo sensor is a complementary metal oxide semiconductor (CMOS) and has a wide angle image taking capability; and wherein the light emitting member is a light-emitting diode (LED) for emitting red light.

7. The optical keyboard of claim 1, wherein the at least one actuation sensing module comprises three actuation sensing modules, the actuation sensing modules are disposed at both ends of the front frame member and a midpoint of the rear frame member respectively.

8. An optical keyboard comprising:
a key assembly for alphanumeric data input, the key assembly including a rectangular keypad housing in a numeric keypad of the key assembly; and
at least one actuation sensing module disposed on a periphery of the keypad housing, each of the at least one actuation sensing module including a light emitting member for emitting light directed to a predetermined space above the key assembly within the keypad housing so as to create a sensing zone, and a photo sensor for sensing light emitted from the light emitting member.

9. The optical keyboard of claim 8, wherein the key assembly comprises a plurality of keys, a plurality of scissor-type structures, a film circuit board, and a base board, and wherein the key is adapted to press and pivotably mounted on a top of the scissor-type structure, the scissor-type structure is a pivotal element and pivotably mounted on a top of the base board, the film circuit board disposed between the scissor-type structures and the base board serves as a conductive element in response to a depressing of the key, and the base board is a support under the film circuit board.

10. The optical keyboard of claim 8, further comprising a signal processing unit electrically connected to the at least one actuation sensing module for receiving and processing a signal representing a change of an optical path, the signal processing unit being adapted to determine whether a finger is sliding or about to press the key, and create a signal representing a key to be touched instruction containing a corresponding coordinate.

11. The optical keyboard of claim 10, further comprising a switch unit, a signal sensing unit, and a signal output unit, wherein the signal sensing unit is electrically connected to the key assembly and the signal processing unit and adapted to determine a signal representing the depressed key and a signal representing a key to be touched instruction containing a corresponding coordinate; the switch unit is electrically connected to the signal sensing unit and adapted to toggle between an operating mode of pressing key and an operating mode of a key to be touched; and the signal output unit is electrically connected to the signal sensing unit, adapted to receive either the signal representing the depressed key or the signal representing a key to be touched, and send the signal to a computer.

12. The optical keyboard of claim 8, further comprising a plurality of reflective members disposed on an inner surface of the keypad housing, the reflective members being adapted to generate signals representing reflection when light directed toward itself being blocked.

13. The optical keyboard of claim 8, wherein the photo sensor is a complementary metal oxide semiconductor (CMOS) and has a wide angle image taking capability; and wherein the light emitting member is a light-emitting diode (LED) for emitting red light.

14. The optical keyboard of claim 8, further comprising a touch panel as a replacement of the numeric keypad of the key assembly.
